(19) United States
(12) Patent Application Publication
(10) Pub. No.: US 2009/0204958 A1
(43) Pub. Date: Aug. 13, 2009

(54) Method for Starting a Field Device for Process Automation Engineering

(75) Inventor: Hans Kornmeier, Tettnang (DE)

Correspondence Address: BACON & THOMAS, PLLC, 625 SLATERS LANE, FOURTH FLOOR, ALEXANDRIA, VA, 22314-1176, US

(73) Assignee: ENDRESS+HAUSER PROCESS SOLUTIONS AG, Reinach (CH)

(21) Appl. No.: 11/667,928

(22) PCT Filed: Nov. 15, 2005
(86) PCT No.: PCT/EP05/55993

§ 371 Date: Feb. 17, 2009

(30) Foreign Application Priority Data
Nov. 18, 2004 (DE) 10 2004 055 814.0

(51) Int. Cl. G06F 9/445; G06F 15/16

(52) U.S. Cl. 717/178; 709/227

(57) ABSTRACT

A method for the startup of a field device of process automation technology uses a service program which runs on a service unit connectable with the field device and with a field device manufacturer service computer SC via a public network (e.g. Internet). The service program communicates with the field device and reads-out its serial number and software version number. Then the service program communicates with the field device manufacturer service computer and ascertains the current software version number belonging to the serial number of the field device. If the two software version numbers do not agree, a corresponding report is produced and, as required, in a third method step, the current software version is downloaded from the service computer and transferred into the field device.

The invention relates to a method for startup of a field device of process automation technology, as such method is defined in the preamble of claim 1.

In process automation technology, field devices are often applied, which serve for registering and/or influencing process variables. Examples of such field devices are fill level measuring devices, mass flow measuring devices, pressure and temperature measuring devices, etc., which, as sensors, register the corresponding process variables, fill level, flow, e.g. flow rate, pressure and temperature.

Serving for the influencing of process variables are actuators, such as e.g. valves, which control flow of a liquid in a pipeline, or pumps, which control the fill level in a container.

A large number of such field devices are manufactured and sold by the firm, Endress+Hauser®.

As a rule, field devices in modern manufacturing plants are connected via fieldbus systems (Profibus®, Foundation® Fieldbus, etc.) to superordinated units, e.g. control systems or control units, serving for process control, process visualization, process monitoring, as well as for startup of the field devices.

Most often, field bus systems are also integrated into company networks. In this way, process and field device information can be accessed from different areas of an enterprise.

Company networks can also be connected with public networks, e.g. the Internet.

Trouble-free functioning of field devices, respectively, all units, connected to the fieldbus system is of decisive importance for the production process in an enterprise. Production shut-downs due to field device malfunctions can cause significant costs.

Of great importance here is that always the current software versions are being used in the respective field devices. Functionality of a field device is essentially determined by the software running in the field device. Software errors can easily lead to malfunctions and must be eliminated by the field device manufacturer as quickly as possible. As a rule, the customer is informed by the field device manufacturer concerning new software versions for its field devices. Whether the customer replaces the old software versions with the new ones is not guaranteed. Also, there is always a time delay between when new software versions are ready and their use by the customer.

Even at the time of startup of a field device, the software version being used may already be outdated.

An object of the invention is, therefore, to provide a method for startup of a field device of process automation technology, which can be performed easily and cost-favorably for assuring safe operation of a field device.

This object is achieved by the method as defined in claim 1.

Advantageous further developments of the invention are presented in the dependent claims.

An essential idea of the invention is to read-out the serial number and software version number of the field device with the help of a service program during startup of the field device and to compare such information with the corresponding information on a service-server of the field device manufacturer. If a more current software version than that in the field device is available in the service-server, that such is displayed and the user can transfer the new software version into the field device.

The invention will now be explained in greater detail on the basis of an example of an embodiment presented in the drawing, the figures of which show as follows:

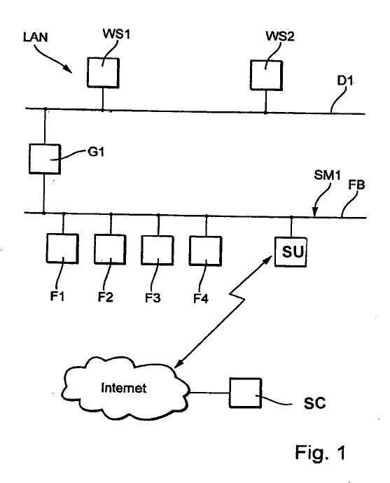

FIG. 1 a schematic drawing of a network of automation technology; and

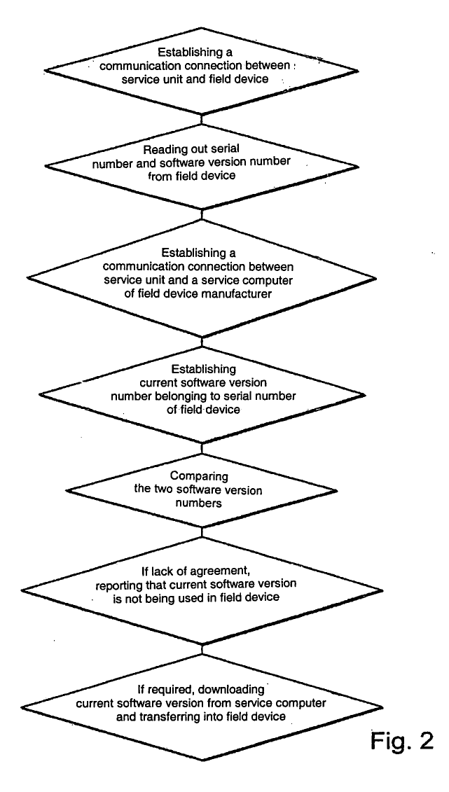

FIG. 2 a flow diagram.

FIG. 1 is a schematic representation of a typical network LAN of automation technology, composed of a data bus D1, to which are connected a plurality of workstations WS1, WS2, which serve as control systems or units. Data bus D1 works, for example, according to the Ethernet standard. Data bus D1 is connected with the fieldbus FB via a gateway G1. Connected to the fieldbus FB are a plurality of field devices F1, F2, F3 and F4, which serve as sensors or actuators for process control. Fieldbus FB works, for example, according to the Profibus® or Foundation® Fieldbus standard.

Also connected to the fieldbus FB is a service unit SU. The service unit SU can, alternatively, also be connected to the data bus D1. With the help of the service unit SU, the field devices connected to the fieldbus FB are serviced and brought into operation. The service unit SU is, furthermore, connected, for example via a radio connection, with a public network (e.g. Internet), to which also a service computer SC operated by the field device manufacturer is connected. On the service computer SC, the field device manufacturer makes available to its customers, among other things, the current software versions for the relevant field devices.

The method of the invention will now be explained in greater detail.

The service unit SU is connected either with the fieldbus FB and or, alternatively, with a service connection provided at the field device F1.

Running on the service unit SU is a service program SP (e.g. the FieldCare® software of the firm, Endress+Hauser), with which the field device can be placed e.g. in operation.

The method of the invention is explained in more detail on the basis of the flow diagram shown in FIG. 2.

In a first method step, the service program SP communicates with a field device, e.g. the field device F1, and reads-out its serial number and software version number. The serial number uniquely identifies the field device.

In a further method step, the service program SP communicates with the service computer SC and ascertains the current software version number belonging to the serial number of the field device F1.

If there is lack of agreement between the two version numbers, then it is evident that the field device will not operate with the most current software version. Outdated software versions can, among other things, lead to malfunctions or, in the worst case, failure of the field device F1.

Therefore it is displayed to the user that the field device is no longer working with the most current software version.

The user has then the opportunity to download the current software version for the field device F1 from the service computer SC and to transfer such into the field device F1.

The connection between the service unit SU and the service computer SC can be safety critical, since a connection between the network LAN and a public network is established thereby. Firewalls, which normally protect internal company networks against public networks, are circumvented in this case. This safety risk can, however, nevertheless, be minimized by appropriate measures. One option is to establish an encrypted connection via a VPN (Virtual Private Network). A firewall can be installed on the service unit SU, which protects the company local network against unauthorized access from outside. Another option for a safety measure is access protection via a one-time password with RSA authentication.

The invention is not only suited for startup of field devices but also for later service work, where the field device needs to be accessed.

Displayed to the user, e.g. to a service technician, is, also in this case, information on whether the most current software version is being used in the field device. In the appropriate situation, the most current version can be downloaded from the service computer SC.

1-5. (canceled)

6. A method for the startup of a field device of process automation technology with a service program running on a service unit, the service unit being connectable with the field device and with a service computer via a public network, comprising the steps of:
communicating the service program with the field device to read-out its serial number and software version number;
communicating the service program with a field device manufacturer service computer and ascertaining the current software version number belonging to the serial number of the field device; and
if there is lack of agreement between the software version numbers, producing a corresponding report and, if required, the current software version is downloaded from the service computer and transferred into the field device.

7. The method as claimed in claim 6, wherein:
the service program works according to an FDT standard (Specification 1.2 or higher).

8. The method as claimed in claim 6, wherein:
a secure communication connection is established between the service unit and the service server.

9. The method as claimed in claim 6, wherein:
the service unit is connected with a fieldbus.

10. The method as claimed in claim 6, wherein:
the service unit is directly connected with the field device.
